(19) United States
(12) Patent Application Publication
(10) Pub. No.: US 2018/0297832 A1
(43) Pub. Date: Oct. 18, 2018

(54) DISPOSABLE KEG FOR FOOD LIQUIDS

(71) Applicant: TRUE KEG S.R.L., VERONA (IT)

(72) Inventor: Massimo FABBRI, VERONA (IT)

(73) Assignee: TRUE KEG S.R.L., VERONA (IT)

(21) Appl. No.: 15/767,722

(22) PCT Filed: Oct. 14, 2016
(86) PCT No.: PCT/IB2016/056153

§ 371 Date: Apr. 12, 2018

(30) Foreign Application Priority Data
Oct. 15, 2015 (IT) 102015000061959
Oct. 15, 2015 (IT) 102015000061970
Oct. 15, 2015 (IT) 102015000061984

(51) Int. Cl. B67D 1/04; B67D 1/08

(52) U.S. Cl. CPC B67D 1/0462; B67D 1/0835; B67D 2001/0811; B67D 2001/0828; B67D 2001/0824

(57) ABSTRACT

A disposable keg for food liquids (L) comprising an outer container (20) made of polymeric material that includes a neck (21), a deformable bag (30) susceptible to house the food liquid (L) therein and a valve assembly (60) placed in correspondence to the neck (21) of the outer container (20).

### FIELD OF APPLICATION

The present invention is generally applicable to the technical field of supply systems for food drinks, and it particularly relates to a disposable keg for food liquids.

### BACKGROUND OF THE INVENTION

Disposable kegs for food liquids, such as wine, beer, fruit juices or the like are known. As known, in such types of kegs the outer container is intended to be thrown in the garbage after use.

Such disposable kegs include an outer container, an inner multilayer deformable bag susceptible to house the food liquid therein and means for the feeding of the food liquid. Generally, the latter include a system for the inflow of a pressurized fluid in the interspace between the outer container and the inner bag, so as to compress the latter by promoting the outflow of the food liquid.

Examples of such known kegs are known from Italian patents IT1324006 and IT1354085, as well as from documents EP1736421, EP1997746 and EP2038187 in the name of Eurokeg BV; EP2152486, EP2148771 and EP2152494 in the name of Inbev SA; EP1803657 in the name of VAP Srl; EP0389191.

Such known disposable kegs may be improved.

### SUMMARY OF THE INVENTION

Object of the present invention is to at least partially overcome the above mentioned drawbacks, by providing a disposable keg having features of high functionality, constructional simplicity and low cost.

Another object of the invention is to provide a keg that has a relatively high durability.

Such objects, and others that will appear more clearly hereinafter, are fulfilled by a disposable keg according to what is herein described, claimed and/or shown.

Advantageous embodiments of the invention are defined in according to the appended claims.

### BRIEF DESCRIPTION OF THE DRAWINGS

Further features and advantages of the invention will become more apparent by reading the detailed description of a preferred but not exclusive embodiment of a disposable keg 1, shown as non-limiting example with the help of the annexed figures, wherein:

FIG. 1 is a schematic view of a feeding system D of food drinks;

FIG. 2 is an enlarged section view of some details of the container 1;

FIG. 3 is an exploded section view of some details of FIG. 2;

FIGS. 4a and 4b are, respectively, an axonometric and a top view of the base element 61;

FIGS. 5a and 5b are, respectively, an axonometric and a top view of the valve body 62;

FIG. 6 is an axonometric view of the unitary closing assembly 70;

FIG. 7 is an axonometric view of a detail of the disposable keg 1 in one embodiment thereof;

FIG. 8 is an exploded side view of a detail of the disposable keg 1 in a different embodiment.

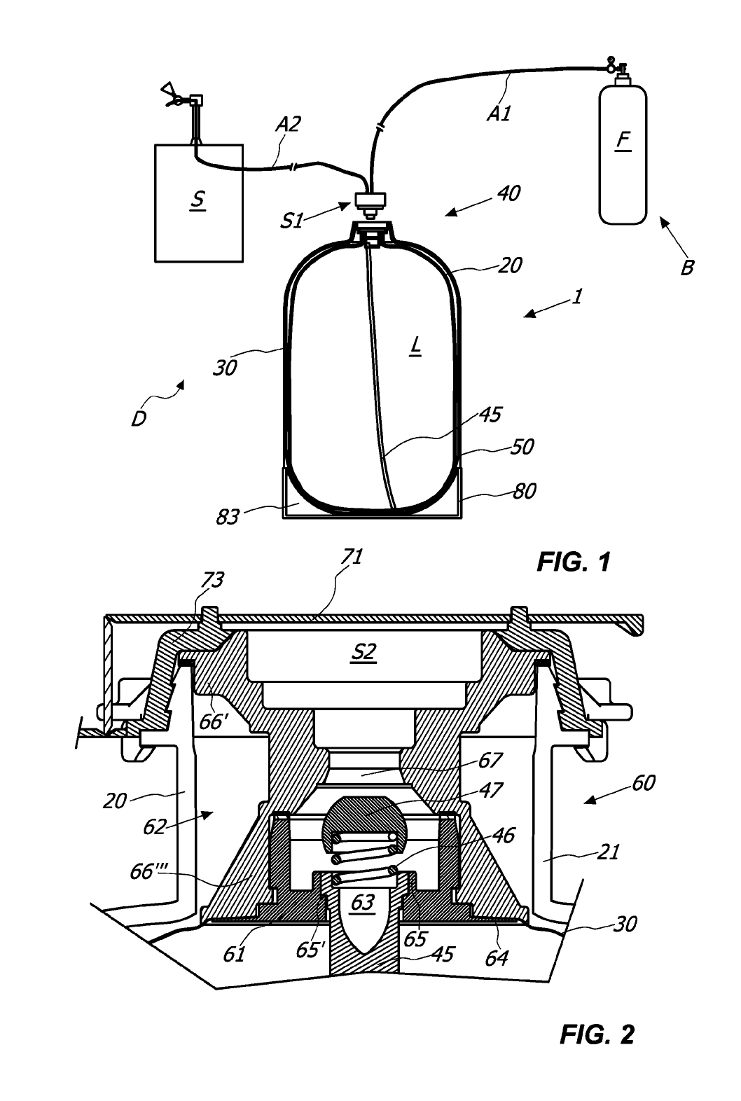

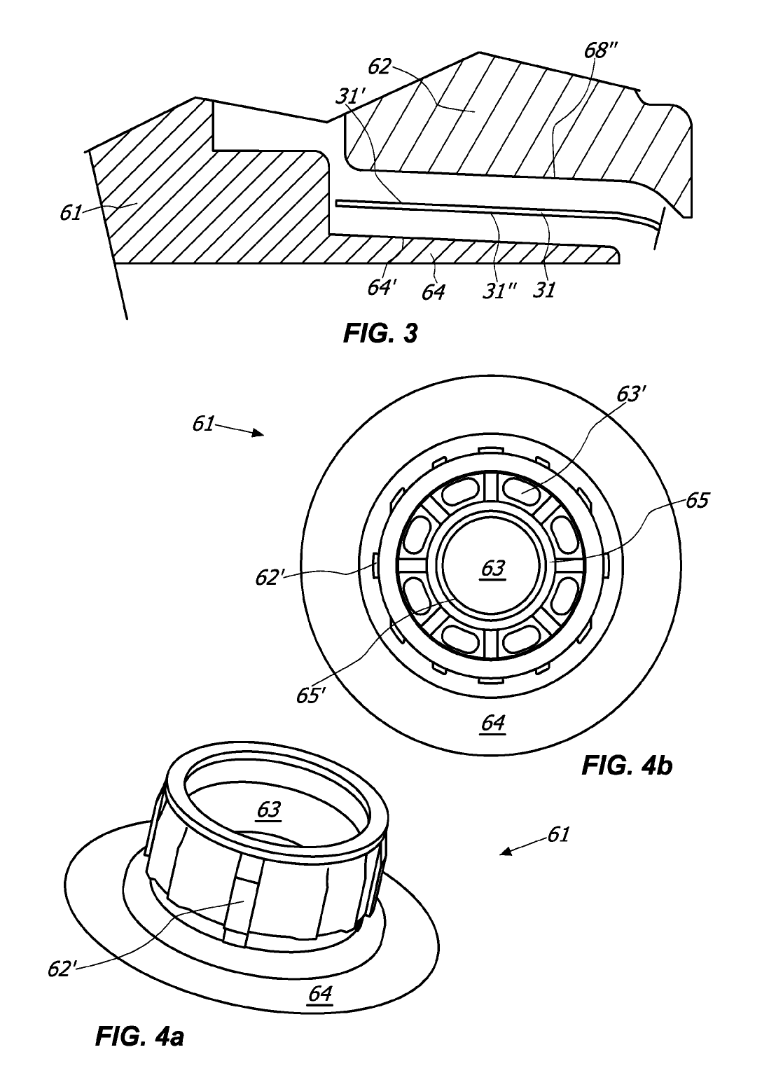

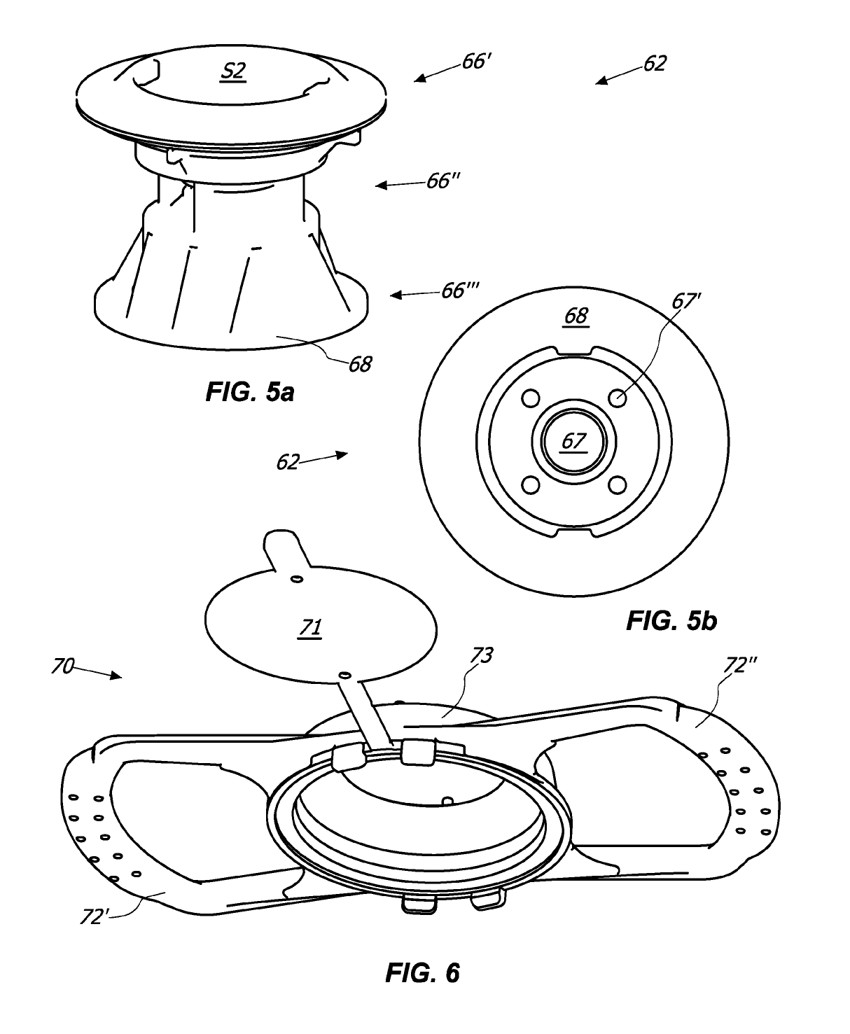

### DETAILED DESCRIPTION OF SOME PREFERRED EMBODIMENTS

With reference to the above mentioned figures, the disposable keg 1 may be advantageously used for the supply of food drinks L, for example beer, wine or fruit juice. The keg 1 may be installed in a supply system D in an area of use such as a bar, a pub, a wine bar, a restaurant or the like to tap measured quantities of liquid by means of a tapping device S.

The system D, of a per se known type, may also comprise a pressurized tank B of a working fluid F and means for the supply A of the food liquid L to the tapping device. In particular, a first line A1 may be provided for the supply of the working fluid F to the disposable keg 1 and a second line A2 for the supply of the food liquid L to the tapping device S. The lines A1 and A2 include a coupler S1 to be connected to the disposable keg to bring thereto the working fluid F and to bring the food liquid L to the tapping device S.

The disposable keg 1 may essentially comprise an outer container 20 and a deformable bag 30 placed inside the latter.

Moreover, means 40 for the feeding of the food liquid L into the tapping device S may be provided.

Essentially, such feeding means 40 allow the inflow of the working fluid F, for example carbon dioxide or compressed air, in the interspace 50 between the outer container 20 and the deformable bag 30 and the supply of the food liquid L from the inside of the deformable bag 30 to the outside, in particular towards the tapping device S.

In a per se known way, the working fluid F compresses from the outside the deformable bag 30 to allow the rise of the liquid along the cannula 45, that is in fluid communication with the line A2 by means of a valve assembly 60.

Suitably, the deformable bag 30 may be manufactured, for example, according to the teachings of the document GB2295373, to which reference is made for consultation.

Advantageously, the deformable bag 30 may be made of a multilayer material that includes at least one first layer 31 of food grade polymeric material, such as polyethylene (PE), at least one second layer 32 of polymeric material, for example nylon, and at least one metallic layer 33, for example aluminium.

In a particularly preferred but not exclusive embodiment, the metallic layer 33 may be interposed between the first two polymeric layers 31, 32 to prevent the entry of pollutants inside the deformable bag 30.

In fact, the metallic material acts as a barrier to possible pollutants, for example residues of detergents, oils or plasticizers, present in the interspace 50 and/or conveyed by the working fluid F. In this way, the integrity of the food liquid L is preserved.

The outer container 20 may be made of a polymeric material with a matrix of polyethylene terephthalate (PET), and it may include a restricted section or neck 21 where the valve assembly 60 may be placed.

The latter may include a base element 61 and a valve body 62, reciprocally coupled therebetween, for example by joint means 62′.

The base element 61 may have a cylindrical shape with a coaxial hole 63 and a plurality of holes 63 peripheral thereto, so as to increase the flow area for the food liquid L. The base element 61 may further include a peripheral annular flange 64.

In a preferred but not exclusive embodiment, the hole 63 may include peripherally an annular appendix 65 spaced apart from the hole 63 thereof such as to leave an abutment surface 65′ for the cannula 45 interposed therebetween, the latter in its turn supports a counteracting spring 46 susceptible to push the closing stopper 47 towards the closing, as better explained later. The peripheral holes 63′ may be placed peripherally to the annular appendix 65.

The valve body 62 may have an upper portion shaped as a divergent truncated cone 66′ defining a seat S2 for the coupler Si, a central cylindrical portion 66″ and a lower portion shaped as a convergent truncated cone 66″, that may include an end portion 68.

The cylindrical central portion 66″ may comprise a coaxial hole 67 and a plurality of peripheral holes 67′ fluidly communicating with the container 20 and with the seat S2 for the inflow of the working fluid F in the interspace 50. This minimizes the load losses of the working fluid F along the line A1.

The closing stopper 47 may be pushed towards the closed position against the hole 67 by the counteracting spring 46. The assembly of the valve assembly 60 is very simple, since it is sufficient to insert the cannula 45 in the base element 61, to insert the spring 46 thereon with the closing stopper 47 and to couple everything to the valve body 62 by means of the joint means 62′.

Advantageously, the deformable bag 30 may be interposed between the base element 61 and the valve body 62.

More particularly, the end portion 31 of the deformable bag 30 may have a lower surface 31″ that may be welded in a per se known manner to the upper surface 64′ of the peripheral annular flange 64 of the base element 61.

Moreover, upon the coupling of the base element 61 and the valve body 62, the reciprocal dimensions of the latter may make the upper surface 31′ of the end portion 31 of the deformable bag 30 come in contact with the lower surface 68″ of the end portion 68 of the valve body 62.

Thanks to such features, de-couplings between the valve assembly 60 and the deformable bag 30 due to changes in pressure may be avoided. In fact, the end portion 31 of the bag 30, remains interposed between two continuous annular surfaces, thus minimizing the danger of de-couplings.

In a preferred but not exclusive embodiment of the invention, the neck 21 of the container 20 may include a unitary closing assembly 70 thereof that includes a closing plug 71 and a pair of handles 72′, 72″ to handle the disposable keg 1, monolithically joined therebetween.

More particularly, both the closing plug 71 and the handles 72′, 72″ may be monolithically joined to a cylindrical load-bearing element 73, to be screwed on the neck 21 of the container 20.

This greatly simplifies the assembly of the disposable keg, since with by screwing a single piece on the container, a double function is accomplished.

According to a further aspect of the invention, the disposable keg 1 may comprise a base element, for example a bottom member 80, that may couple with the container 20 to impart stability to the disposable keg 1.

In fact, thanks to such a feature, it may be possible to place the disposable keg 1 on a support surface without making the former roll and/or fall.

More particularly, the bottom member 80 may have a substantially flat first support portion 81 and a second annular portion 82 substantially perpendicular to the first portion 81. Suitably, the latter may be spaced apart from the outer container 20 so as to define an interspace 83 therebetween.

In order to make the entire bottom member 80 lighter, the second annular portion 82 and/or the first support portion 81 may comprise a plurality of passing-through openings 84.

According to another aspect of the invention, the disposable keg 1 may comprise at least one element to detect at least one physical quantity 90 of the area surrounding the disposable keg 1 thereof and/or at least one element for the identification and/or the storing of information regarding the disposable keg 1.

More particularly, the at least one element to detect at least one physical quantity 90 of the area surrounding the disposable keg 1 may be susceptible to detect any physical quantity, such as temperature, pressure or humidity.

Certainly, depending on the physical quantity to be detected the configuration of the element 90 varies, such as a thermometer to measure the temperature, a barometer to measure the pressure and a hygrometer to measure the humidity.

On the other hand, the at least one element for the identification and/or the storing of information may identify and/or store any information or data, for example the temperature, pressure or humidity thereof referred above, and in this case it is operatively connected to the at least one element to detect at least one physical quantity 90 of the area surrounding the disposable keg 1, or data concerning the food liquid contained in the keg, for example the type of liquid, the date or the bottling factory or the expiry date of the liquid thereof.

The at least one element to detect at least one physical quantity of the area 90 surrounding the disposable keg 1 and/or the at least one element for the identification and/or the storing of information regarding the disposable keg 1 may be placed inside the interspace 83, and more particularly, they may be coupled to the outer container 20.

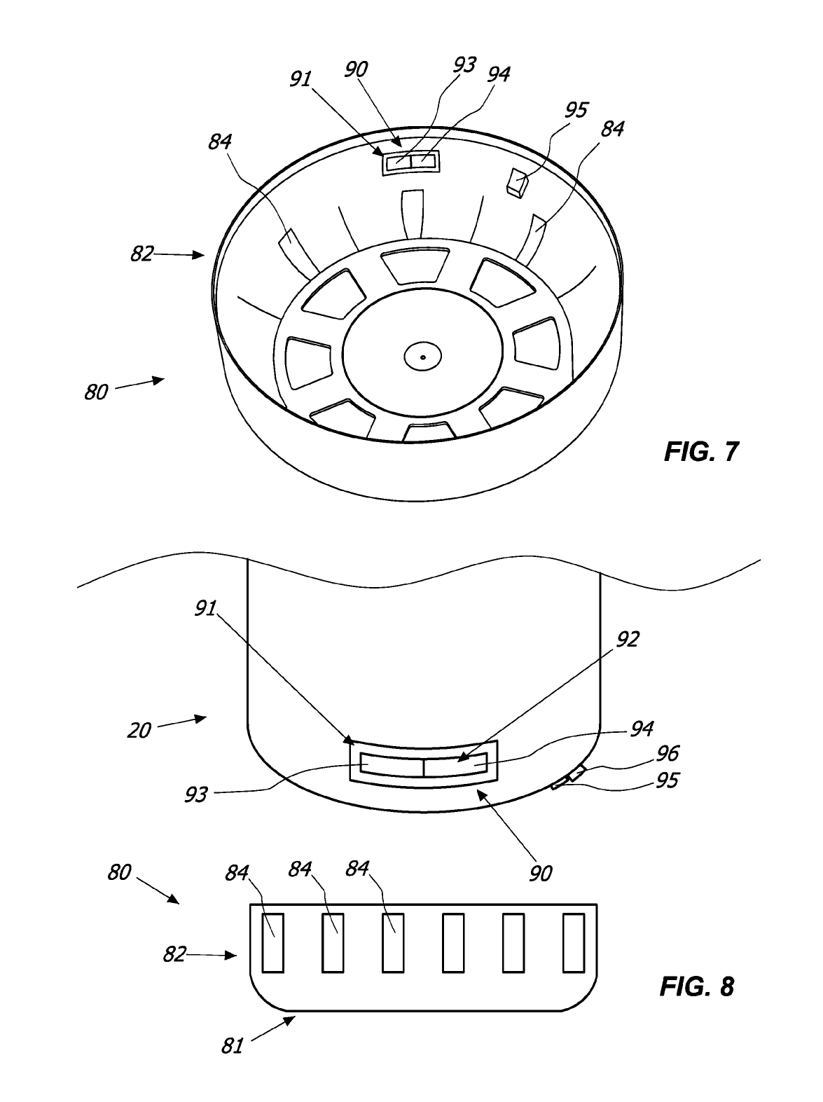

Suitably, such as shown in FIG. 7, the at least one element to detect at least one physical quantity 90 of the area surrounding the disposable keg 1 and/or the at least one element for the identification and/or the storing of information regarding the disposable keg 1 may be coupled to the bottom member 80, inside the interspace 83.

A particularly significant physical quantity to be detected is the temperature as the food drinks L generally have a maximum temperature and a minimum temperature that should not be exceeded in order not to deteriorate the product thereof.

Even though hereinafter we refer only to the temperature, it is understood that any physical quantity of the area surrounding the disposable keg 1 may be detected without departing from the scope of the appended claims.

The at least one element to detect at least one physical quantity 90 of the area surrounding the disposable keg 1 may comprise a laminar element 91 having at least one temperature indicator 92 visible from the outside by a user.

Suitably, the laminar element 91 and at least one of the passing-through openings 84 may be reciprocally placed so as the temperature indicator 92 is visible from the outside through at least one of the passing-through openings 84.

On the other hand, the laminar element 91 and the bottom member 80 may be reciprocally configured so as the temperature indicator 92 is inaccessible to the user's hand, so as to prevent the improper removal thereof.

It is understood that any element to detect at least one physical quantity 90 of the area surrounding the disposable keg 1 and/or any element for the identification and/or the storing of information regarding the disposable keg 1 may be visible through at least one of the passing-through openings 84 and/or may be inaccessible to the user's hand without departing from the scope of the appended claims.

The temperature indicator 92 may have a first predetermined code, for example a colour code, susceptible to vary following the achievement of a predetermined maximum and/or minimum temperature. In particular, such a variation of the first code may be irreversible.

Furthermore, the temperature indicator 92 may comprise at least one first portion 93 having a first code susceptible to vary in response to the achievement of the maximum temperature and a second portion 94 having a second code susceptible to vary in response to the achievement of the minimum temperature.

For example, the first portion 93 may be initially green and it may change the colour thereof to red upon reaching the predetermined maximum temperature, for example 40° C. in case the food liquid is beer. In fact, above such a temperature, the beer degrades.

On the other hand, the second portion 94 may be initially green and it may change the colour thereof to red upon reaching the predetermined minimum temperature, for example 0° C. in case the food liquid is beer. In fact, below such a temperature, the beer flocculates.

In this way, a user may identify if the disposable keg 1 has reached the predetermined maximum and/or minimum temperature, in particular, the food drink L may be properly kept when both the first and the second portions 93, 94 are green.

According to a further aspect of the invention, at least one element for the identification and/or the storing of information regarding the disposable keg 1 may comprise a RFID tag 95, that may be placed in the interspace 83 so as to be protected against accidental impacts and to be substantially inaccessible to the user's hand so as to prevent the improper removal thereof from the disposable keg 1.

Suitably, the at least one element for the identification and/or the storing of information regarding the disposable keg 1 may be operatively connected to an element to detect at least one physical quantity of the area surrounding the disposable keg 1, for example a temperature sensor 96, that may be operatively connected to the RFID tag 95.

The RFID tag 95 may be initially activated by a user in order to store the temperature for a predetermined time period, for example every 5 seconds.

Suitably, therefore, the RFID tag 95 may be operatively connected to a logic unit of data storage to store such parameters, or some of them, detected by means of detection of parameters 96.

In other words, the RFID tag 95 may store a plurality of data, including the maximum and minimum temperature reached by the disposable keg 1.

The RFID tag 95 may be a RFID tag of a per se known type. In particular, it may be operatively connected to an outer device, for example a RFID tags reader, to send and/or receive data to/from the latter.

For example, the RFID tag 95, more in particular the storage unit, may store the maximum and/or a minimum temperature parameters received by the detecting means of the parameters 96 and it may store, for example, the expiry date and/or the manufacturing date received from the outer device.

The disposable keg 1 may alternatively or simultaneously comprise the RFID tag 95 and the temperature indicator 92 without departing from the scope of protection of the present invention.

According to a further aspect of the invention, the outer container 20 and/or the bottom member 80 may have indicator means of the improper reciprocal decoupling. For example, the outer container 20 and the bottom member 80 may be coupled by means of a glue that leaves solid scraps in case of improper decoupling between the container 20 and the bottom member 80 thereof.

In this way, the final user may verify both the integrity of the disposable keg 1 and the value of the parameters in order to verify the correct preservation of the disposable keg 1 thereof, and, therefore, of the food drink L.

From the above description, it is evident that the invention fulfils the intended objects.

The invention is susceptible of numerous modifications and variations all falling within the inventive concept expressed in the appended claims. All the details may be replaced with other technically equivalent elements, and the materials may be different according to requirements, without departing from the scope of the invention.

Although the invention has been described with particular reference to the annexed figures, the reference numbers used in the description and in the claims are used to improve the intelligence of the invention and do not constitute any limitation to the scope of protection claimed.

1. A disposable keg for a food liquid to be used with a tapping system, comprising:
an outer container made of polymeric material, the outer container including a neck;
a deformable bag adapted to internally house the food liquid, the bag being housed inside the outer container;
a supply member for supplying the food liquid to the tapping system, the supply member comprising a valve assembly placed at the neck of the outer container, the valve assembly including a base element and a valve casing reciprocally coupled to each other;
wherein the valve casing includes a lower surface, the base element includes an upper surface susceptible to remain faced to the lower surface, and the deformable hag has a portion interposed between the lower and upper surfaces and in contact therewith.

2. (canceled)

3. (canceled)

4. (canceled)

5. Disposable keg according to claim 1, wherein the base element and the valve casing respectively include a first hole and a second hole for the passage of the food liquid.

6. Disposable keg according to claim 5, wherein the valve assembly further includes a valve body pushed on the first hole by a counteracting elastic member that abuts on the base element.

7. (canceled)

8. (canceled)

9. Disposable keg according to claim 1, wherein the lower surface has a substantially annular shape, the base element having an annular flange that includes the upper surface.

10. Disposable keg according to claim 1, wherein the tapping system comprises a coupler, the valve casing has cylindrical central portion comprising the second hole, a lower portion that includes the lower surface and a shaped upper portion defining a seat for the coupler.

11. Disposable keg according to claim 10, wherein the second hole is coaxial with the central portion, the central portion further comprising a plurality of peripheral holes fluidly communicating with the outer container and with the upper portion for the inflow of a working fluid the interspace between the outer container and the deformable bag.

12. Disposable keg according to claim 1, wherein the base element has a cylindrical shape, the first hole of the base element being coaxial therewith, the base element further including a plurality of holes peripheral with respect to the first hole.

13. Disposable keg according to claim 12, wherein the supply member comprises a suction cannula for sucking the food liquid, the first hole peripherally including an annular appendix spaced apart from the first hole to act as an abutment surface for the end of the cannula, the annular appendix supporting the counteracting elastic member, the peripheral holes being placed peripherally to the annular appendix.

14. Disposable keg according to claim 1, wherein the neck of the outer container further includes a closing plug and at a handle to handle the disposable keg.

15. Disposable keg according to claim 14, wherein the closing plug and the handle are reciprocally monolithically coupled to a load-bearing cylindrical element to be screwed on the neck of the container to form a unitary closing assembly.

16. (canceled)

17. (canceled)

18. Disposable keg according to claim 1, comprising a bottom member coupled to the outer container.

19. Disposable keg according to claim 18, wherein the bottom member and the outer container are reciprocally configured to define an interspace therebetween.

20. Disposable keg according to claim 19, wherein the bottom member has a substantially flat first abutment portion and a second annular portion substantially perpendicular to the first portion the first abutment portion being spaced apart from the outer container so as to define the interspace.

21. (canceled)

22. (canceled)

23. (canceled)

24. (canceled)

25. (canceled)

26. (canceled)

27. (canceled)

28. (canceled)

29. (canceled)

30. Disposable keg according to claim 18, wherein the container and/or said or the bottom member has an indication system indicating that the improper reciprocal decoupling has been accomplished.

31. Disposable keg according to claim 30, wherein the indication system comprises a glue that leaves solid scraps in the event of improper decoupling between the container and the bottom member.
